(19) United States
(12) Patent Application Publication
(10) Pub. No.: US 2016/0138654 A1
(43) Pub. Date: May 19, 2016

(54) FLOATING WIND TURBINE BEARING SEAL WITH ENHANCED PROFILE

(71) Applicant: Parker-Hannifin Corporation, Cleveland, OH (US)

(72) Inventors: Philip Martin Thomas, Jr., Greenville, SC (US); James Blanding Upshur, Moore, SC (US); Scott A. VanLuvender, New Baltimore, MI (US); Dennis McCarthy, Brighton, MI (US)

(21) Appl. No.: 14/940,235

(22) Filed: Nov. 13, 2015

Related U.S. Application Data
(60) Provisional application No. 62/081,685, filed on Nov. 19, 2014.

(51) Int. Cl. F16C 33/78; F16C 43/04; F16C 33/66

(52) U.S. Cl. CPC F16C 33/7836; F16C 33/7823; F16C 33/664; F16C 43/04

(57) ABSTRACT

A bearing seal assembly is provided for sealing a sealing gap defined by a first race and a second race of a bearing. The bearing seal assembly includes a resilient seal having a cross-sectional profile, wherein the profile defines a flexing portion, and the resilient seal further has a first pressure-bearing side and a second side opposite the first pressure-bearing side. The flexing portion is configured to flex to form an energized seal that seals the sealing gap when a pressure is applied to the first side of the resilient seal, wherein the cross-sectional profile is symmetric about a horizontal axis and asymmetric about a vertical axis. The cross-sectional profile specifically may be a K-shaped profile, and the flexing portion comprises arms defined by the K-shaped profile. The assembly may include a wear strip section positioned outside of the profile of the resilient seal, with a removable blast shield.

### RELATED APPLICATIONS

This application claims the benefit of U.S. Provisional Application No. 62/081,685 filed Nov. 19, 2014, which is incorporated herein by reference.

### FIELD OF THE INVENTION

The present invention is directed to a wind turbine bearing seal, and more particularly to a floating wind turbine bearing seal having an enhanced profile for sealing the space between wind turbine bearings.

### BACKGROUND OF THE INVENTION

Wind turbines employ bearing structures to control the pitch and yaw of a wind turbine. Conventionally, a yaw bearing permits the turbine blades to turn toward the wind, and a pitch bearing can control the angle of the blades to optimize the force of the incoming wind to turn the blades.

A conventional wind turbine bearing assembly typically is of a type of bearing assembly referred to in art as a “slewing bearing” or “slewing ring bearing”. Such bearing assemblies generally include two concentric ring structures, commonly referred to in the art as “races”. The races define or form a track or recess therebetween, into which a plurality of ball bearings, roller bearings, or similar bearing components may be placed. In such an assembly, with ball or roller bearings in a track formed by two concentric races, the races may rotate relative to one another. It will be appreciated that wind turbine bearing assemblies are quite large, with the races tending to have a diameter of approximately eight to ten feet or more. With structures of such size, which often are made of metal components, wear of the bearing structures needs to be minimized.

The configuration of a slewing ring bearing has a high load carrying capacity, and thus can be utilized in a versatile range of applications, including wind turbines. Due to their design, a slewing ring bearing can reliably support radial, axial and tilting moment loads. It is therefore possible in many cases to replace bearing arrangements including a combination of radial and axial bearings by a single bearing. This reduces the costs and work required in the design of the adjacent structures and the fitting of bearings in a variety of applications, including wind turbines.

To minimize friction as between the relative movements of the ball bearings and races, a lubricating material, such as a lubricating grease, is provided within the track and adjacent surfaces so as to coat the races and ball bearings in areas where they contact. The lubricating material or grease increases the freedom of movement of the bearing structures, which reduces friction and wear. Typically, however, adjacent top and bottom surfaces of the races where they come together, a small space between the two races tends to be present outward from the ball bearings in both directions perpendicularly to the track. The lubricating material or grease, therefore, would leak out from the area of the track and ball bearings unless the space between the races is sealed.

To prevent leakage of the lubricating material or grease, a bearing seal may be provided between the races and in the area of the referenced space between them. Bearing seals also prevent contamination of internal bearing components by external environmental contaminants. Conventional configurations of wind turbine bearing seals, however, have proven deficient. In such conventional configurations, the bearing seal is attached to one or the other of the races. A significant internal torque is generated of the unattached race against the bearing seal. As the races move relative to one another, therefore, the unattached race causes significant wearing of the bearing seal. Wind turbine bearing seals, therefore, typically are subject to intense wear and must be replaced often. A worn seal increases the propensity for leakage of the lubricating material or grease. In addition, once a significant portion of the lubricating material leaks, wearing of the ball bearings and races can reduce the efficiency of the wind turbine, and a severe case of wear can result in damage and failure of the wind turbine components.

### SUMMARY OF THE INVENTION

The present invention provides an enhanced bearing seal assembly that is less subject to wear as compared to conventional configurations. In exemplary embodiments, a bearing seal assembly is provided for sealing a sealing gap defined by a first race and a second race of a bearing. The bearing seal assembly includes a resilient seal having a cross-sectional profile, wherein the profile defines a flexing portion, and the resilient seal further has a first pressure-bearing side and a second side opposite the first pressure-bearing side. The flexing portion is configured to flex to form an energized seal that seals the sealing gap when a pressure is applied to the first side of the resilient seal, wherein the cross-sectional profile is symmetric about a horizontal axis and asymmetric about a vertical axis. The cross-sectional profile specifically may be a K-shaped profile, and the flexing portion comprises arms defined by the K-shaped profile.

Another aspect of the invention is a bearing assembly including a first race and a second race that define a sealing gap, and the bearing seal assembly that seals the sealing gap.

The bearing seal assembly may include a wear strip section positioned outside of the profile of the resilient seal. The wear strip section may include a first wear strip portion located outside one side of the profile, and a second wear strip portion located outside of the profile oppositely to the first wear strip portion. The wear strip section further may include a removable blast shield that prevents contamination of the bearing seal assembly during installation. Prior to removal, the blast shield connects the first wear strip portion to the second wear strip portion, and removal of the blast shield separates the first wear strip portion from the second wear strip portion.

Another aspect of the invention is a method of assembling a bearing seal assembly. In exemplary embodiments, the method may include the steps of: providing a bearing seal; positioning the bearing seal within a wear strip section having a blast shield to form a seal assembly; compressing the seal assembly with a compressive force; providing a bearing assembly including a first race and a second race that define a sealing gap; inserting the seal assembly into the sealing gap of the bearing assembly; releasing the compressive force; and removing the blast shield. The method further may include subjecting the bearing seal assembly to a coating process prior to removing the blast shield.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto. Features that are described and/or illustrated with respect to one embodiment may be used in the same way or in a similar way in one or more other embodiments and/or in combination with or instead of the features of the other embodiments.

### BRIEF DESCRIPTION OF DRAWINGS

FIG. 1 is a three-dimensional perspective view depicting an exemplary slewing ring bearing assembly in accordance with embodiments of the present invention.

FIG. 2 is a schematic diagram depicting a cross-sectional view of an exemplary embodiment of a bearing seal assembly in a portion of the bearing assembly denoted by the oval indicator A in FIG. 1.

FIG. 3 is a schematic diagram depicting a cross-sectional view of another exemplary embodiment of a bearing seal assembly in the portion of the bearing assembly denoted by the oval indicator A in FIG. 1, including a bearing seal in conjunction with a wear strip section.

FIG. 4 is a schematic diagram depicting a cross-sectional view of an exemplary bearing seal assembly including a bearing seal in conjunction with a wear strip section having a flexing blast shield.

FIG. 5 is a schematic diagram depicting a cross-sectional view of another exemplary embodiment of a bearing seal assembly in the portion of the bearing assembly denoted by the oval indicator A in FIG. 1, including a bearing seal in conjunction with a wear strip section having a flexing blast shield.

FIG. 6 is a flow chart depicting an exemplary method of assembling a bearing seal assembly in accordance with embodiments of the present invention.

### DETAILED DESCRIPTION

Embodiments of the present invention will now be described with reference to the drawings, wherein like reference numerals are used to refer to like elements throughout. It will be understood that the figures are not necessarily to scale.

The present invention provides an improved bearing seal and seal assembly for use in a wind turbine bearing. The wind turbine bearing seal and seal assembly of the present invention reduce wear as compared to conventional configurations, while maintaining an effective seal against high-pressure leakage of the lubricating material or grease and against external environmental contaminants.

In accordance with such features, an aspect of the invention is a bearing seal assembly for sealing a sealing gap defined by a first race and a second race of a bearing. Embodiments of the bearing seal assembly may include a resilient seal having a cross-sectional profile. The profile defines a flexing portion, and the resilient seal further has a first pressure-bearing side and a second side opposite the first pressure-bearing side. The flexing portion is configured to flex to form an energized seal that seals the sealing gap when a pressure is applied to the first pressure-bearing side of the resilient seal. The cross-sectional profile may be symmetric about the horizontal axis and asymmetric about the vertical axis, and may be a K-shaped profile in particular. Embodiments of the bearing seal assembly may also include a wear strip section positioned outside of the profile of the resilient seal.

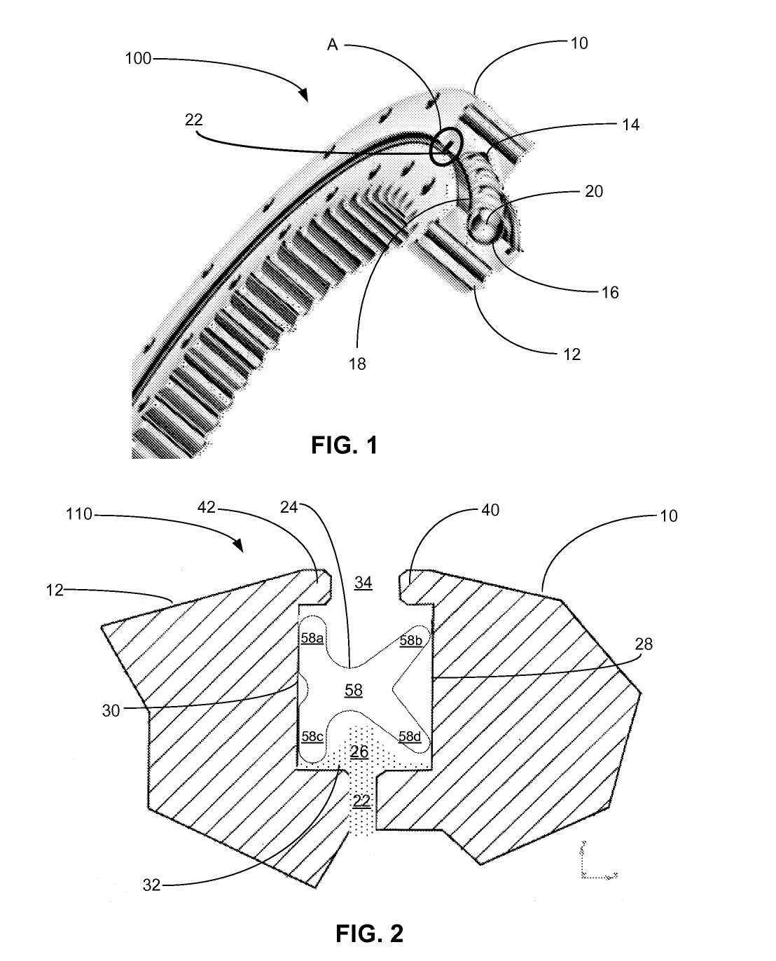

FIG. 1 depicts an exemplary bearing assembly 100 in accordance with embodiments of the present invention. For example, the bearing assembly may be a slewing ring bearing assembly that may be used as a wind turbine bearing assembly. Similarly to the description above, the bearing assembly 100 includes two concentric races, a first or outer race 10 and a second or inner race 12. The outer race 10 has a first recess 14, and the inner race 12 has a second recess 16, which together form a track 18 therebetween. A plurality of ball or roller bearings 20 are positioned within the track 18. In this assembly, with ball or roller bearings 20 positioned within the track 18 between the two concentric races, the races 10 and 12 may rotate relative to one another. FIG. 1 depicts a portion of the wind turbine bearing assembly 100, and it will be appreciated that in a full bearing assembly the races and associated structures will extend circularly over a full 360 degrees so as to form a complete slewing ring bearing.

The races and ball or roller bearings may be made of metal and/or metal alloys that are sufficiently strong to support movement of the wind turbine blades. Titanium, steel, aluminum, or other metals, or combinations thereof, may be employed as are known in the art. The ball or roller bearings 20 can spin within the track 18, which permits the races 10 and 12 to rotate about a center axis of the bearing assembly in opposite directions relative to each other and in concentric fashion.

To minimize friction as between the movements of the ball/roller bearings and races, a lubricating material, such as a high performance lubricating grease, is provided within the track 18 and adjacent surfaces so as to coat the races 10/12 and ball bearings 20 in areas where they contact. The lubricating material may be a petroleum based grease or gell, or any comparable lubricants as are known in the art for reducing friction as between moving parts, and moving metal parts in particular. The lubricating material or grease increases the freedom of movement of the bearing structures, which reduces friction and wear. Typically, however, on both sides of the ball bearings in a direction perpendicularly to the track 18, small spaces 22 are present between the two races. The lubricating material or grease, therefore, would leak out from the area of the track 18 unless the spaces 22 between the races are sealed on both sides of the ball bearings.

To prevent leakage of the lubricating material or grease, a resilient bearing seal 24 may be provided between races 10 and 12 within a sealing gap 26 defined by the races at locations outward from the ball bearings 20 in a direction perpendicularly to the track 18. The bearing seal 24 and commensurate sealing gap 26 extend concentrically between the races over the full 360 degrees of the complete slewing ring bearing 100. The resilient bearing seal 24 may be made of a resilient polymer material, rubber or rubber-like material, plastics, thermoplastics, and/or other resilient and flexible materials and combinations thereof as are known in the art to be used for seals. Essentially, any material suitable for a wind turbine bearing seal may be employed to form the bearing seal 24.

Although the present invention is described principally in connection with a bearing assembly formed of concentric races as depicted in FIG. 1, other bearing configurations may be employed. For example, the bearing seal described herein may be employed in connection with thrust bearing assemblies. In such bearing assemblies, the races typically are stacked in the axial direction, with the track being defined by the axial faces of the races. For example, the first race 10 and the second race 12 may be stacked in the axial direction and define a track 18 that is in fluid communication with the sealing gap. A plurality of at least one of ball bearings or roller bearings may be located within the track that permit the first race to rotate in an opposite direction relative to the second race. A lubricating material may for lubricate the ball or roller bearings and the races. The the bearing seal assembly is thus configured to seal the bearing assembly to prevent leakage of the lubricating material from the sealing gap. The bearing seal configurations described herein, therefore, may provide for effective sealing in both radial and axial configurations, and the invention is not limited to any specific configuration of the races.

FIG. 2 is a schematic diagram depicting a cross-sectional view of a portion 110 of the slewing ring bearing assembly 100 in the area denoted by the oval A in FIG. 1. FIG. 2 depicts the space 22, the sealing gap 26, and the resilient bearing seal 24 in a more close-up view. The sealing gap 26 is defined by the outer race 10 and inner race 12. Using FIG. 2 as a reference, the ball bearings and track (not shown in FIG. 2) would be located at a position below the depicted space 22. On the other side of the track and ball bearings, a configuration of structures essentially the same as FIG. 2 would be present, except the structures would be flipped about the horizontal axis such that the space 22 would be above the sealing gap 26 rather than below. In other words, as stated above, a sealing gap and bearing seal are provided on both, opposite sides of the ball bearings in the direction perpendicularly to the track.

The outer race 10 has a first inside surface 28, and the inner race 12 has a second inside surface 30. The two inside surfaces define the sealing gap 26 and space 22 between the races. As represented by the patterning in FIG. 2, a lubricating material 32 may be provided in a portion of the sealing gap 26 adjacent the space 22. The lubricating material would, therefore, extend into and around the space 22, ball bearings 20, and track 18 so as to lubricate the ball bearings 20 and races 10/12 in the areas where they principally would contact as the structures of the bearing assembly move. The lubricating material 32, therefore, reduces the friction of the ball bearings 20 spinning within the track 18 as the races 10 and 12 rotate relative to each other. In this manner, the lubricating material 32 reduces the wear of the moveable components.

It will be appreciated that in the absence of the bearing seal 24, the lubricating material 32 would simply leak out of the bearing assembly from the sealing gap 26, through an additional outer gap 34 defined by the races, and then to the outside. The bearing seal 24 effectively prevents any significant leakage of the lubricating material through the outer gap 34. The bearing seal 24 also prevents contamination of internal bearing components by external environmental contaminants.

To aid in positioning the bearing seal 24 within the sealing gap 26, the outer race 10 includes an outer race ridge 40, and the inner race 12 includes an inner race ridge 42. The outer and inner race ridges 40/42 maintain the bearing seal 24 within the sealing gap 26. In part because of the race ridges, the bearing seal 24 need not be attached to or fixed to either of the outer (first) or inner (second) races 10 or 12. Rather, the bearing seal rests unattached or “floats” within the sealing gap 26. The bearing seal 24, therefore, is referred to a “floating seal”. A floating bearing seal of the present invention differs from the conventional bearing seal that is fixed to one or other of the races. Because the bearing seal 24 floats in the sealing gap 26, as the races rotate around the seal, the internal torque is diminished as compared to a configuration in which the seal is attached to or fixed to one of the races. As stated above, the unattached race generates a torque as to the fixed bearing seal, which can increase the wearing of the seal, particularly at the initiation of the movement of the races. Because the bearing seal of the present invention floats, this additional torque between a race and the bearing seal is effectively reduced. The configuration of the present invention, therefore, reduces wear as compared to the conventional configurations by reducing the internal torque that results from conventional fixed bearing seals.

As stated above, the bearing seal 24 extends concentrically between the outer race 10 and the inner race 12. As further seen in FIG. 2, the bearing seal 24 has a cross-sectional profile 58. The cross-sectional profile 58 generally may be symmetric about a horizontal axis but asymmetric about a vertical axis. For example, the profile 58 may be asymmetric about a vertical “Y” axis shown in FIG. 2, and also symmetric about a horizontal “X” axis also shown in FIG. 2. In the exemplary embodiment of FIG. 2, the profile 58 is a “K-shaped” profile having arms 58a, 58b, 58c, and 58d. In this manner, the profile 58 includes an upper half 58ab symmetric as to a lower half 58cd, and a left half 58ac asymmetric as to a right half 58bd. The seal profile 58 may be formed by molding or extruding the seal material with the K-shaped profile during manufacture.

As the races of the wind turbine bearing rotate relative to each other, outward pressure of the lubricating material tends to increase substantially within the sealing gap 26. This increased pressure can force the various arms of the bearing seal profile against one or more of the race inside surfaces 28 and 30 at various points. In particular, the cross-sectional profile 58 defines a flexing portion that is configured to flex to form an energized seal that seals the sealing gap. The seal has a first pressure-bearing side and a second side opposite the first side. The first pressure-bearing side may be defined by the two lower arms 58c and 58d, and the second side may be defined by the two opposite arms 58a and 58b of the K-shaped profile. The profile defines a flexing portion in that the arms flex when the increased pressure within the bearing seal assembly is applied to the first pressure-bearing side of the seal. The arms 58c and 58d that define the first pressure-bearing side in particular tend to flex upon an increase in the pressure. In this manner, the flexing portion is configured to flex to form an energized seal that seals the sealing gap when a pressure is applied to the first side of the resilient seal.

The K-shaped profile, therefore, has an advantage in that the arms may flex in response to the increased pressure within the bearing seal assembly. Coupled with the floating configuration described above, the K-shaped profile and the floating configuration substantially reduce the wear of the bearing seal. The seal of the present invention, therefore, lasts longer and provides an enhanced seal as compared to conventional configurations while maintaining an effective seal under increased pressure of the lubricating material.

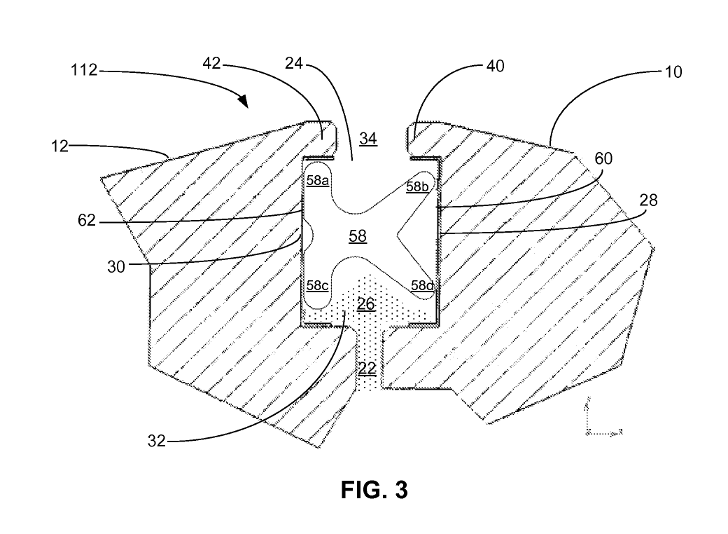

FIG. 3 is a schematic diagram depicting a cross-sectional view of another exemplary embodiment 112 of a bearing seal assembly in the portion of the bearing assembly 100 in the area denoted by oval A in FIG. 1. The embodiment of FIG. 3 bears many similarities to the embodiment of FIG. 2, and like components are denoted with like reference numerals. In particular, the bearing seal 24 of FIG. 3 also is a floating seal having a profile that is asymmetric about the vertical axis and symmetric about the horizontal axis, and a K-shaped profile in particular.

The embodiment of FIG. 3 further includes a wear strip section that is positioned outside of the profile 58 of the bearing seal. In the particular embodiment of FIG. 3, the wear strip section includes a first or outer race wear strip portion 60 located outside of one side of the profile 58 and adjacent the first inside surface 28 of the outer race 10. Such embodiment also includes a second or inner race wear strip portion 62 located outside of the profile 58 oppositely to the first outer race wear strip portion and adjacent to the second inside surface 30 of the inner race 12. The wear strip portions 60 and 62 provide an additional protection against wear of the bearing seal 24.

The wear strip portions may be made of materials comparable to the materials used to make the bearing seal 24. Such materials, for example, may include a resilient polymer material, rubber or rubber-like materials, plastics, thermoplastics, epoxies, and/or other resilient and flexible materials and combinations thereof as are known in the art to be used for seals. The wear strip portions 60 and 62 further reduce friction as between the bearing seal 24 and the races 10/12, thereby enhancing the floating seal characteristics of the bearing seal. Similarly to the embodiment of FIG. 2, the bearing seal assembly of FIG. 3 may be a floating seal assembly that is not attached to or fixed rigidly to either of the outer (first) or inner (second) races. The wear strip portions optionally may be adhered to the races with the bearing seal itself being configured as a floating bearing seal. In other words, at least a portion of the wear strip section may be attached to one of the races, and the bearing seal is a floating seal that is not attached to either of the first race, the second race, or the wear strip section.

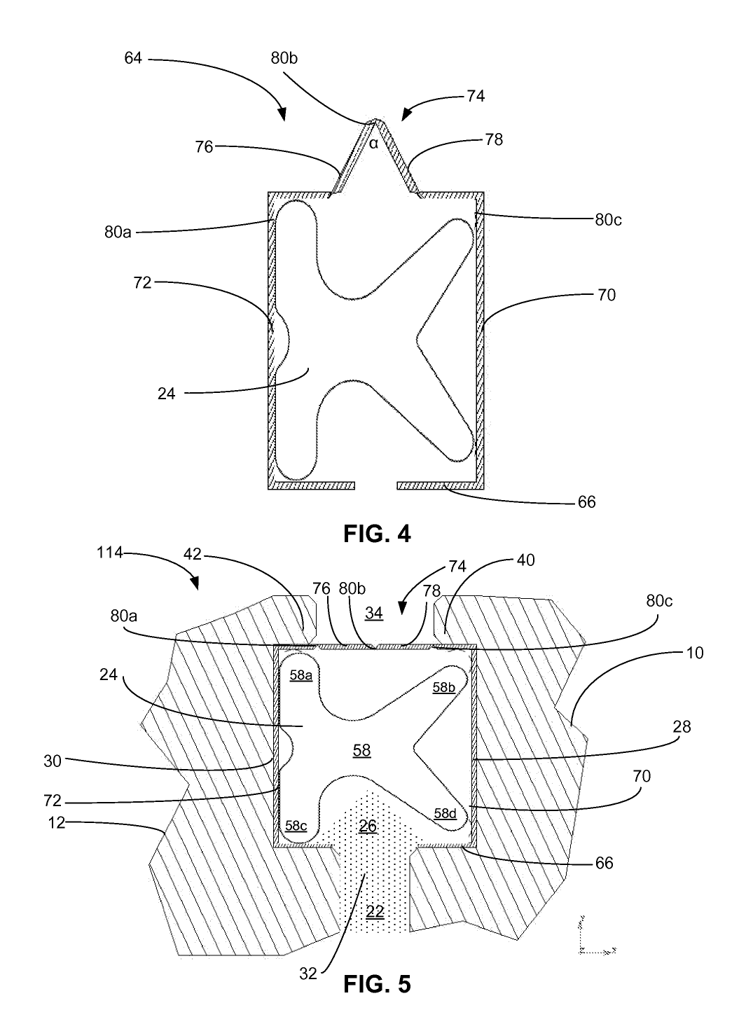

FIGS. 4 and 5 depict another exemplary embodiment of the bearing seal 24 as utilized in conjunction with a wear strip section 66. As additional background, it is common that, as part of a finishing process, the outer portions of the races are painted or coated. It is undesirable, however, for the coating material and/or paint to contact the bearing seal. It is also undesirable for the coating material and/or paint to penetrate the bearing assembly to the area of the ball bearings and track because the coating material could interfere with rotation of the races about the ball bearings, increase seal wear, and adversely affect seal performance. Accordingly, with a conventional bearing assembly, a bearing seal is placed into the sealing gap during the coating process. Because the bearing seal becomes substantially coated with the coating material, this first or initial bearing seal is removed and replaced with a second bearing seal for actual use.

The present invention obviates the need in the conventional configuration to utilize a first bearing seal during coating, which then is removed and replaced with a second bearing seal for actual use. Rather, in the present invention only one bearing seal is required.

FIG. 4 a schematic diagram depicting a cross-sectional view of an exemplary seal assembly 64 that includes the bearing seal 24 and a wear strip section 66. As in the other figures, the bearing seal 24 depicted in FIG. 4 has a K-shaped profile. The bearing seal 24 may be substantially enclosed within the wear strip section 66. The enclosure of the wear strip section 66 typically would not be a totally closed structure, but may contain an opening in a bottom portion of the wear strip section 66. Generally, as stated above, the wear strip section 66 is positioned outside of the profile 58 of the bearing seal 24. The wear strip section 66 may include a first wear strip portion 70 and a second wear strip portion 72 that are separated in part by the referenced opening in the wear strip section 66. The wear strip section 66 may also include a flexing, removable blast shield 74 that may include a first segment 76 and a second segment 78 that are moveable about flexing points 80a, 80b, and 80c. The blast shield 74 connects the first and second wear strip portions 70 and 72. To permit the flexing, the wear strip section 66 may be notched or otherwise weakened at the flexing points as compared to the remainder of the wear strip section.

The bearing seal assembly 64 may be formed by a variety of processes that would result in the bearing seal 24 being inside the wear strip section 66. For example, to form the bearing seal assembly the bearing seal and the wear strip section 66 may be molded together, or separately formed with the bearing seal being subsequently inserted or installed into the wear strip section to locate the wear strip section outside of the profile of the bearing seal such that the bearing seal is within the wear strip section.

As seen in FIG. 4, the bearing seal 24 has been compressed into a first compressed state as compared to a second uncompressed state as depicted, for example, in FIG. 5. The bearing seal 24 may be compressed into the compressed state by applying a compressive force with any suitable mechanical means. In the first compressed stated, the arms of the bearing seal profile 58 are compressed such that the arms 58a and 58c respectively are compressed closer to the arms 58b and 58d. In this first compressed state, the blast shield 74 is also compressed such that first segment 76 and second segment 78 of the blast shield are oriented in an angular configuration with a vertex at flexing point 80b. In such angular configuration, first segment 76 extends from the flexing point 80b to the flexing point 80a, and second segment 78 extends from flexing point 80b to the flexing point 80c, thereby forming an angle α between the segments 76 and 78.

FIG. 5 is a schematic diagram depicting a cross-sectional view of another exemplary embodiment 114 of a bearing seal assembly in the portion of the bearing assembly 100 in the area denoted by oval A in FIG. 1. The embodiment of FIG. 5 bears many similarities to the embodiments of FIGS. 2 and 3, and like components are denoted with like reference numerals. When the seal assembly 64 is in the first compressed state of FIG. 4, with sufficient compression the seal assembly is insertable through the outer gap 34 and into the sealing gap 26 defined by the inner and outer races. After the seal assembly is positioned within the sealing gap 26, the compressive force may be released. Because the bearing seal 24 and wear strip section 66 are made of resilient materials, upon releasing the compressive force, the sealing assembly reconfigures into a second uncompressed state shown in FIG. 5 (and FIG. 3) to seal the sealing gap. In this second uncompressed state, the blast shield is in a linear configuration in which first segment 76 and second segment 78 are linearly aligned, rather than aligned angularly as depicted in FIG. 4.

In the configuration of FIG. 5, the bearing assembly may be subjected to a coating process without a significant risk of coating material being applied to the internal components around and including the ball bearings and the track. Instead, the blast shield 74 prevents coating material from entering the sealing gap 26, thereby preventing the coating material from contaminating the bearing seal 24, as well as the more internal structures such as the ball bearings and track.

While in the second uncompressed state, the blast shield is removable, and removal of the blast shield separates the first wear strip portion 70 from the second wear strip portion 72. As stated above, to permit the flexing of the blast shield components, the wear strip section 66 may be notched or otherwise weakened at the flexing points 80a-c as compared to the remainder of the wear strip section. After a coating process is completed, the blast shield 74 may be removed from the remainder of the wear strip section 66. For example, the blast shield may be torn or stripped away at the flexing points 80a and 80c from the remainder of the wear strip section 66. In this manner, flexing portions 80a and 80c in particular permit the blast shield 74 to be effectively “unzipped” from the remainder of the wear strip section 66.

The resultant configuration is that of FIG. 3. When the blast shield is unzipped or stripped away, the wear strip portions 70 and 72 of FIG. 5 are separated from each other and effectively become the wear strip portions 60 and 62 depicted in FIG. 3. Accordingly, a first bearing seal does not need to be removed and replaced with a second bearing seal after a coating and/or painting process as is performed in connection with the conventional bearing seal configuration. Rather, only the blast shield needs to be removed. In addition, similarly to the embodiments of FIGS. 2 and 4, the bearing seal assembly of FIG. 5 may be a floating seal assembly that is not attached to or fixed rigidly to either of the outer (first) or inner (second) races. The wear strip portions optionally may be adhered to the races with the bearing seal itself being configured as a floating bearing seal. In other words, at least a portion of the wear strip section may be attached to one of the races, and the bearing seal is a floating seal that is not attached to either of the first race, the second race, or the wear strip section.

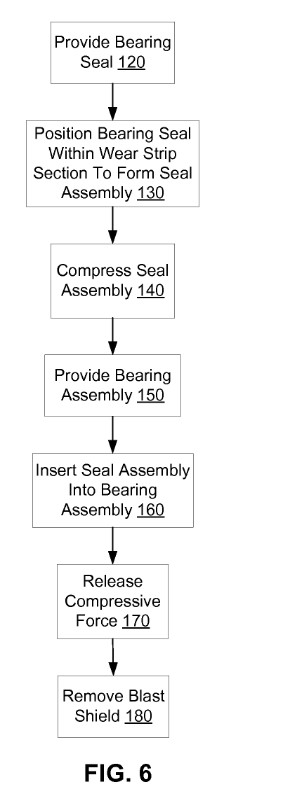

In accordance with the above, FIG. 6 is a flow chart depicting an exemplary method of assembling a bearing seal assembly, such as a wind turbine bearing seal assembly, in accordance with embodiments of the present invention. Although the exemplary method is described as a specific order of executing functional logic steps, the order of executing the steps may be changed relative to the order described. Also, two or more steps described in succession may be executed concurrently or with partial concurrence. It is understood that all such variations are within the scope of the present invention.

The method may begin at step 120, in which a bearing seal, such as the bearing seal 24, is provided. At step 130, the bearing seal may be positioned within a wear strip section having a blast shield, such as the wear strip section 66 having the blast shield 74, to form a seal assembly such as the seal assembly 64. It will be appreciated that both the timing and manner of steps 120 and 130 may be varied and/or combined. For example, as stated above, to form the seal assembly the bearing seal and the wear strip section may be molded together, or formed separately with the bearing seal subsequently being inserted or installed into the wear strip section to locate the bearing seal within the wear strip section.

At step 140, the seal assembly may be compressed in the horizontal direction with a compressive force, such as, for example, depicted in FIG. 4. At step 150, a bearing assembly may be provided, with the bearing assembly including an outer race and an inner race that define a sealing gap as described above. At step 160, the seal assembly may be inserted into the sealing gap of the bearing assembly, and at step 170 the compressive force may be released. The result of step 170 would be a configuration comparable to that depicted in FIG. 5. At step 180, the blast shield may be removed, such as by stripping away or unzipping the blast shield as described above. The result is a bearing seal assembly having a configuration comparable to that depicted in FIG. 3. The bearing seal assembly may be subjected to a coating process prior to removing the blast shield in step 180.

The bearing seal and associated structures described in this disclosure have advantages over conventional configurations. The described bearing seal is provided in a floating configuration and has a profile that is asymmetric about the vertical axis and symmetric about the horizontal axes, and may have a K-shaped profile in particular. The floating configuration combined with a symmetrical profile substantially reduces internal torque generated by the bearing assembly during use. The reduced internal torque results in a substantial reduction of seal wear, which prolongs the life of the seal while precluding leakage of the lubricating material. The use of a wear strip section further reduces such internal torque. The additional blast shield of the wear strip section also protects the bearing seal and other internal bearing components during a coating process. There is no need, therefore, to employ one bearing seal during coating, and then replacing this first bearing seal with a second bearing seal for actual use. The described bearing seal, therefore, is simpler and more efficient to assemble and install as compared to conventional configurations.

An aspect of the invention, therefore, is a bearing seal assembly for sealing a sealing gap defined by a first race and a second race of a bearing. In exemplary embodiments, the bearing seal assembly includes a resilient seal having a cross-sectional profile, wherein the profile defines a flexing portion, and the resilient seal further has a first pressure-bearing side and a second side opposite the first pressure-bearing side. The flexing portion is configured to flex to form an energized seal that seals the sealing gap when a pressure is applied to the first side of the resilient seal, and wherein the cross-sectional profile is symmetric about a horizontal axis and asymmetric about a vertical axis. The bearing seal assembly may include one or more of the following features either individually or in combination.

In an exemplary embodiment of the bearing seal assembly, the cross-sectional profile is a K-shaped profile, and the flexing portion comprises arms defined by the K-shaped profile.

In an exemplary embodiment of the bearing seal assembly, the first pressure -bearing side is defined by two of the arms of the K-shaped profile, and the second side is defined by two opposite arms of the K-shaped profile.

In an exemplary embodiment of the bearing seal assembly, the bearing seal assembly further includes a wear strip section positioned outside of the profile of the resilient seal.

In an exemplary embodiment of the bearing seal assembly, the wear strip section comprises a first wear strip portion located outside one side of the profile, and a second wear strip portion located outside of the profile oppositely to the first wear strip portion.

In an exemplary embodiment of the bearing seal assembly, the wear strip section further comprises a removable blast shield that prior to removal, connects the first wear strip portion to the second wear strip portion, and removal of the blast shield separates the first wear strip portion from the second wear strip portion.

In an exemplary embodiment of the bearing seal assembly, the blast shield comprises a first segment and a second segment, and the bearing seal assembly is compressible with a compressive force. In a first compressed state of the bearing seal assembly, the first and second segments of the blast shield are oriented in an angular configuration, and in a second uncompressed state of the bearing seal assembly, the first and second segments of the blast shield are linearly aligned. In the first compressed state the bearing seal assembly is insertable into the sealing gap, and upon release of the compressive force, the bearing seal assembly reconfigures to the second uncompressed state to seal the sealing gap.

In an exemplary embodiment of the bearing seal assembly, the blast shield is removable when the bearing seal assembly is in the second uncompressed state.

Another aspect of the invention is a bearing assembly including a first race and a second race that define a sealing gap, and the bearing seal assembly that seals the sealing gap. The bearing assembly may include one or more of the following features either individually or in combination.

In an exemplary embodiment of the bearing assembly, the first race and the second race are concentric races and define a track that is in fluid communication with the sealing gap. The bearing assembly further includes a plurality of ball bearings or roller bearings located within the track that permit the first race to rotate concentrically and in an opposite direction relative to the second race, and a lubricating material for lubricating the ball or roller bearings and the races. The bearing seal assembly is configured to seal the bearing assembly to prevent leakage of the lubricating material from the sealing gap.

In an exemplary embodiment of the bearing assembly, the first race and the second race are stacked in the axial direction and define a track that is in fluid communication with the sealing gap. The bearing assembly further includes a plurality of ball bearings or roller bearings located within the track that permit the first race to rotate in an opposite direction relative to the second race, and a lubricating material for lubricating the ball or roller bearings and the races. The bearing seal assembly is configured to seal the bearing assembly to prevent leakage of the lubricating material from the sealing gap.

In an exemplary embodiment of the bearing assembly, the bearing seal assembly is a floating seal assembly that is not attached to either of the first race or the second race.

In an exemplary embodiment of the bearing assembly, the bearing seal assembly includes a wear strip, wherein at least a portion of the wear strip section is attached to one of the races, and the bearing seal is a floating seal that is not attached to either of the first race, the second race, or the wear strip section.

In an exemplary embodiment of the bearing assembly, resilient seal is energized when a pressure of the lubricating material is applied to the first pressure-bearing side of the resilient seal.

In an exemplary embodiment of the bearing assembly, the bearing assembly is a wind turbine bearing assembly.

Another aspect of the invention is a method of assembling a bearing seal assembly. In exemplary embodiments, the method may include the steps of: providing a bearing seal; positioning the bearing seal within a wear strip section having a blast shield to form a seal assembly; compressing the seal assembly with a compressive force; providing a bearing assembly including a first race and a second race that define a sealing gap; inserting the seal assembly into the sealing gap of the bearing assembly; releasing the compressive force; and removing the blast shield. The method further may include subjecting the bearing seal assembly to a coating process prior to removing the blast shield.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A bearing seal assembly for sealing a sealing gap defined by a first race and a second race of a bearing, the bearing seal assembly comprising:
a resilient seal having a cross-sectional profile, wherein the profile defines a flexing portion, and the resilient seal further has a first pressure-bearing side and a second side opposite the first pressure-bearing side;
wherein the flexing portion is configured to flex to form an energized seal that seals the sealing gap when a pressure is applied to the first side of the resilient seal; and
wherein the cross-sectional profile is symmetric about a horizontal axis and asymmetric about a vertical axis.

2. The bearing seal assembly of claim 1, wherein the cross-sectional profile is a K-shaped profile, and the flexing portion comprises arms defined by the K-shaped profile.

3. The bearing seal assembly of claim 2, wherein the first pressure-bearing side is defined by two of the arms of the K-shaped profile, and the second side is defined by two opposite arms of the K-shaped profile.

4. The bearing seal assembly of any of claim 1, further comprising a wear strip section positioned outside of the profile of the resilient seal.

5. The bearing seal assembly of claim 4, wherein the wear strip section comprises a first wear strip portion located outside one side of the profile, and a second wear strip portion located outside of the profile oppositely to the first wear strip portion.

6. The bearing seal assembly of claim 5, wherein the wear strip section further comprises a removable blast shield that prior to removal, connects the first wear strip portion to the second wear strip portion, and removal of the blast shield separates the first wear strip portion from the second wear strip portion.

7. The bearing seal assembly of claim 6, wherein the blast shield comprises a first segment and a second segment, and the bearing seal assembly is compressible with a compressive force, and further wherein:
in a first compressed state of the bearing seal assembly, the first and second segments of the blast shield are oriented in an angular configuration, and in a second uncompressed state of the bearing seal assembly, the first and second segments of the blast shield are linearly aligned; and
in the first compressed state the bearing seal assembly is insertable into the sealing gap, and upon release of the compressive force, the bearing seal assembly reconfigures to the second uncompressed state to seal the sealing gap.

8. The bearing seal assembly of claim 7, wherein the blast shield is removable when the bearing seal assembly is in the second uncompressed state.

9. A bearing assembly comprising:
a first race and a second race that define a sealing gap; and
the bearing seal assembly of claim 1.

10. The bearing assembly of claim 9, wherein the first race and the second race are concentric races and define a track that is in fluid communication with the sealing gap, and further comprising:
a plurality of ball bearings or roller bearings located within the track that permit the first race to rotate concentrically and in an opposite direction relative to the second race; and
a lubricating material for lubricating the ball or roller bearings and the races;
wherein the bearing seal assembly is configured to seal the bearing assembly to prevent leakage of the lubricating material from the sealing gap.

11. The bearing assembly of claim 9, wherein the first race and the second race are stacked in the axial direction and define a track that is in fluid communication with the sealing gap, and further comprising:
a plurality of ball bearings or roller bearings located within the track that permit the first race to rotate in an opposite direction relative to the second race; and
a lubricating material for lubricating the ball or roller bearings and the races;
wherein the bearing seal assembly is configured to seal the bearing assembly to prevent leakage of the lubricating material from the sealing gap.

12. The bearing assembly of claim 9, wherein the bearing seal assembly is a floating seal assembly that is not attached to either of the first race or the second race.

13. A bearing assembly comprising:
a first race and a second race that define a sealing gap; and
the bearing seal assembly of claim 4;
wherein at least a portion of the wear strip section is attached to one of the races, and the bearing seal is a floating seal that is not attached to either of the first race, the second race, or the wear strip section.

14. The bearing assembly of claim 9, wherein resilient seal is energized when a pressure of the lubricating material is applied to the first pressure-bearing side of the resilient seal.

15. The bearing assembly of claim 9, wherein the bearing assembly is a wind turbine bearing assembly.

16. A method of assembling a bearing seal assembly comprising the steps of:
providing a bearing seal;
positioning the bearing seal within a wear strip section having a blast shield to form a seal assembly;
compressing the seal assembly with a compressive force;
providing a bearing assembly including a first race and a second race that define a sealing gap;
inserting the seal assembly into the sealing gap of the bearing assembly;
releasing the compressive force; and
removing the blast shield.

17. The method of claim 16, further comprising subjecting the bearing seal assembly to a coating process prior to removing the blast shield.
